(19) United States
(12) Patent Application Publication
(10) Pub. No.: US 2015/0174833 A1
(43) Pub. Date: Jun. 25, 2015

(54) METHOD FOR MANUFACTURING COMPOSITE PARTS, MANUFACTURING FACILITY IMPLEMENTING SUCH A METHOD, AND COMPOSITE PARTS MANUFACTURED THEREBY

(71) Applicant: Aircelle, Gonfreville L'Orcher (FR)

(72) Inventor: Bertrand DESJOYEAUX, Sainte Adresse (FR)

(21) Appl. No.: 14/638,386

(22) Filed: Mar. 4, 2015

Related U.S. Application Data
(63) Continuation of application No. PCT/FR2013/052133, filed on Sep. 17, 2013.

(30) Foreign Application Priority Data
Sep. 18, 2012 (FR) 12/58720

(51) Int. Cl. B29C 70/40; B29C 70/02

(52) U.S. Cl. CPC B29C 70/40; B29C 70/021; B29L 2031/772

(57) ABSTRACT

The present disclosure relates to a method for manufacturing composite parts and to manufacturing equipment. The present disclosure is useful in the field of aircraft construction. During a first phase, the part is designed, the geometry is computed, and the fabric architecture of the fabric preform and a mandrel for forming the first state of the preform are calculated. During a second phase, the preform fabric and the mandrel are produced. During a third phase, the mandrel is wrapped with the fabric, the preform is extracted from the mandrel in order to collapse a portion of the preform, and the preform is impregnated in order to obtain the desired part.

### CROSS-REFERENCE TO RELATED APPLICATIONS

This application is a continuation of International Application No. PCT/FR2013/052133, filed on Sep. 17, 2013, which claims the benefit of FR 12/58720, filed on Sep. 18, 2012. The disclosures of the above applications are incorporated herein by reference.

### FIELD

The present disclosure relates to a method for manufacturing composite parts, a manufacturing facility implementing such a method, and to composite parts manufactured thereby. It finds one application in the field of aeronautical construction in particular in the field of nacelles for turbojet engines and more particularly in the field of revolving or circumferential structures of nacelles such as air intake lips or frames of thrust reversers' structures of aircrafts' nacelles.

### BACKGROUND

The statements in this section merely provide background information related to the present disclosure and may not constitute prior art.

A composite part includes a preform with a woven or braided part which is shaped into the shape of the desired part. Then, the preform is impregnated with a polymerizable resin to obtain the final part.

In this state of the art, it is not possible to provide preforms with continuous fibers to drape revolving shapes of which at least one point of the meridian has a radial tangent, and allow their realization in composite materials with continuous fibers. Such a surface cannot be developed, and thus it cannot be properly covered with a fabric in one piece obtained by a conventional method. As is known, a fabric is obtained by intersecting a warp yarn and a weft yarn, warp and weft being substantially orthogonal to each other.

With a fabric obtained by a conventional method, it is almost impossible to deform the orthogonal fabrics (to deframe them) beyond 45°. Deframing consists in changing the angles between the warp and the weft, initially at 90°, to angles comprised between 35° and 125°, which is typically achieved when a fabric is stretched along at least one direction that is not parallel to a direction of the fibers of said fabric. Thus, it is not possible to cover complex shapes such as non-developable surfaces of composite parts used in aeronautics such as an air intake lip, a nacelle front frame, a stiffener with a <<C>>-shaped profile, <<C>>-shaped radial partition wall, etc . . . all shapes of axisymmetric parts or parts that can be assimilated to axisymmetric parts. Thus, we are forced to carry out the draping of a layer in several coupons which are disposed edge-to-edge or with overlaps.

In another state of the art, a tubular braiding method allows covering such shapes. But, on one hand, the orientations of fibers are constrained by technology, and on the other hand, there should be provided a braiding machine with a dimension (number of spindles) compatible with the perimeter of the closed section.

For example, we can use a toroidal core including in its surfaces the shape of the part, and realize a tubular braid directly around this core. The axis of the tubular braid being at any point of the part substantially perpendicular to the toroidal section of the part. This technique allows, if the toroidal section of the part is convex, obtaining a preform conforming to the surface of the part. However, this method is relatively slow to implement and management of the orientations of fibers is limited. Moreover, for complex toroidal geometries, it is hard to properly manage the distribution of the fibers, in particular the fibers that are longitudinal to the shape.

We can also realize a cylindrical tubular braid, then stretch and expand it in diameter in order to conform to the geometry of the part shape. Subject to maximum deframing limitations, we can thus also cover non-developable shapes, and apply shape roll-overs of the tubular braid, such as the method proposed by Document DE102005041940. For shapes of large-sized parts, we won't find a braider capable of braiding tubes with enough perimeter, an alternative may consist in splitting the tubular braid so as to cover only a shape revolving portion. However, these techniques have the drawback of not allowing the installation of longitudinal fibers within the braid because they would prevent stretching of the braid and hence not being able to optimize the mass of the part.

Thus, the following drawbacks of the different states of the art are observed. For the fabric-made solution, multiple pieces should be provided. Hence, the solution is heavy, and it causes constraints on the evolutions of fibers orientations. For the tubular braids-made solutions, the solutions lack flexibility in the orientations and distributions of fibers along the section of the part to be realized, they do not allow optimizing the orientations of the fibers to the mechanical stresses and hence, the mass of the part is not optimized.

These different solutions result in weavings or braidings difficult to implement and the fibrous structure of which is not often performant for stresses thus providing heavy and costly parts.

### SUMMARY

The solution provided by the present disclosure, comprises obtaining the preform according to the contour weaving principle, and with a particular mandrel definition and different from the final part to be draped.

Hence, the present disclosure provides a technique for weaving or braiding a textile so as to be able to continuously cover a revolving or a substantially revolving surface, which textile can then be draped, without cutting over said revolving surface.

By revolving part or circumferential part, it is meant an axisymmetric part extending over 360° or over an angular sector of less than 360°, the section of which, by cutting the part along a plane parallel to the axis of revolution, exhibits, with at least one line perpendicular to the axis of revolution, at least 2 intersection points. For example, a toroidal part meets this definition. The toroidal section of a part according to the present disclosure may be open or closed, regular or irregular.

In the present description which follows, the term <<inflection point>> means a point of a generating line of a preform or a mandrel on which the weaving or braiding of the preform is rolled up, exhibiting a tangent crossing the generating line or two half-tangents placed on either side of the generating line.

To this end, the present disclosure relates to a method for manufacturing composite material parts with preforms obtained by contour weaving of the kind consisting in rolling up at least one part of drape by weaving or by braiding around a mandrel under a field of determined tensions.

The method of the present disclosure comprises:

during a first phase, carrying out the design of the part, the calculation of the geometry and the drape layout of the fabric-made preform and the calculation of at least one mandrel for forming a first manufacturing state of at least one preform;

during a second phase, carrying out the production of said at least one mandrel calculated during the first phase and of the drape of said at least one preform to be rolled up on this mandrel;

during a third phase extracting the preform from its mandrel and applying thereto a determined radial extension, and/or, beyond an inflection point on the rolled up preform and/or into radial extension, a determined geometric transformation which makes it pass from a first manufacturing state to a second and last manufacturing state, and finally, carrying out the impregnation of the preform in order to obtain the desired composite material part.

In the method of the present disclosure, the first phase also includes at least from a determined geometry of the preform to be manufactured:

one step of defining a layout of the drape of the preform to be manufactured the section of which includes at least one extreme line separating at least two portions of the preform;

one step of unfolding at least one portion of the distribution of the drape of the preform eliminating any roll-over along the width of the axisymmetrically-shaped section;

one step for deducting therefrom at least one revolving mandrel exhibiting a developed pattern similar to the distribution of the drape after the previous unfolding step.

In particular, from an adequate meshing of the final state of the preform, geometric transformations of the types planar symmetries, and axial homotheties and linear expansions, are successively applied, in order to obtain the geometric definition of the forming mandrel of the contour weaving.

Thus, the final surface that cannot be woven is transformed with a conventional weaving means, into a surface that can be woven with a conventional loom on mandrels with particular shapes.

Thus, weaving can be quick because a weaving loom has a good productivity.

The mandrel has a particular shape directly related to the final shape of the part to be draped.

The mandrel for rolling up the weaving according to the present disclosure with the inflection point, allows using a conventional loom, and obtaining a fabric from one side to the other of the inflection point, which allows obtaining a continuous fabric on the final part.

Thanks to the non-developable shape of the weaving obtained upon rolling up on the calculated mandrel, the obtained fabric has a specific shape, which is adapted to be draped without stretching on the shape of the part. Hence, the orientations of the fibers on the final part are controlled.

The roll-over point(s) of the final surface of the preform is/are eliminated, this being achieved by the planar symmetry or symmetries.

The profile of the mandrel does not contain any tangent line normal to the axis, which would make weaving of such a shape very difficult, this being obtained by the axial homothety associated with the linear expansion of the surface.

It would not be possible to weave the radial tangent line of the final part with a roll-over according to the conventional weaving looms, the principle consisting in designing the mandrel by performing geometric transformations, allows achieving a compatible mandrel of weaving on a 2D weaving loom.

The fibers of the fabric are then distributed into circumferential fibers (typically the warp yarns) and transverse or radial fibers (typically the weft yarns), these circumferential and radial fibers being perpendicular to each other.

This concept is better achieved that symmetrical weaving patterns (or weaves) will be chosen for covering the two faces of the fabric, such as plain or twill weaves. In particular, it may use this pattern in the inflection area and at least over the weaving portion starting from the inflection area until the end of the returned area. The effect of this being to limit the mismatches of lengths.

For a particular calculation of the mandrel, a fabric which will have transverse fibers at different and pre-determined angles, may be made. Depending on the pre-determined angles and the calculation of the associated mandrel, such a fabric will be then deframed as a whole, the radial fibers then assuming an angle which is no longer perpendicular, which allows to have along the surface, circumferential (or preferably circumferential) fibers and fibers tilted relative to the previous ones, either at right angles, or at various angles which may be alternated from one layer to another in order to provide a substantially mirrored symmetrical stacking according to the thickness.

The solution of the method of the present disclosure uses thus a textile layout associated with a shape type, and the process to obtain it.

The textile layout consists of a woven or braided textile, covering in only one coupon, a geometric shape of which the envelope surface comprises, in at least one plane perpendicular to the axis of revolution or an axis that can be assimilated to an axis of revolution, at least two circumferential generating lines, such as a <<C>>-shape, or a torus. Hence, associated to this characteristic of the surface, there is also found on the surface at least one generating line of which all the points are located at an extreme abscissa relative to the neighboring points, along the axis of revolution for constructing the surface, this generating line constituting a roll-over line of profile of the shape.

The solution of the method of the present disclosure allows covering the surface of such parts by textile weaving in one piece, without distorting or stretching the preform. The characteristics of fibers densities and fibers orientations are controlled and thus confer to the part an excellent and improved structural strength that is not allowed by the other methods for draping conventional 2D fabrics or 2D braids which require stretching in order to conform to the non-developable shape of such parts.

The solution of the method of the present disclosure is based on a modeling process linking the final surface to be draped, and the definition of the mandrels for rolling up the weaving, and the weaving which will be obtained on the part, based on the fabric rolled up on the mandrel during the weaving.

In another form, the method of the present disclosure is such that the first phase includes at least some of the following steps:
E1. meshing of the surface of the part to be draped;
E2. identification of extreme generating lines of the obtained meshed surface ;
E3. generation of a returned meshed surface by turning over the different sub-surfaces of the obtained meshed surface by planar symmetries in order to eliminate the identified extreme generating lines;
E4. generation of a returned and reduced meshed surface by axial reduction from the obtained returned meshed surface (E3) by means of a similitude comprising an axial homothety with a positive coefficient smaller than 1 combined with a linear expansion, according to the rules of preservation of circumferential developed patterns and the rules of preservation of curvilinear distances along the profiles of the surface, between these developed patterns, and finally definition of a mandrel for rolling up fabric exhibiting a developed pattern similar to the returned and reduced meshed surface (E4);
E5. definition of the patterns for the weaving and/or braiding which will be realized and rolled up on said mandrel and by a method of transformations which are reversal to the transformations of the turning-over step (E4) then the reduction step (E3) in correspondence with the distribution which will be obtained on the shape of the part to be draped.

According to another feature, for the calculation of the geometry and the layout of the drape, the transverse fibers have an angle defined relative to the circumferential fibers, which is not necessarily equal to a 90° angle and in that quadrilaterals, that preserve sides having the same ratio between the longitudinal (circumferential) direction and the cross (radial) direction, are gradually generated over the entire surface of the part.

According to another form, the present disclosure also relates to a facility for manufacturing composite parts implementing the method of the present disclosure. According to the present disclosure, the facility basically includes:

a device for calculating a drape layout and a geometry of a preform on the basis of a given shape of a revolving part to be realized in a composite material and at least one mandrel for realizing a drape-made preform of said revolving part;

a device for realizing a drape reproducing the determined drape layout;

a mechanism for rolling up at least partially the drape with the determined layout around said at least one mandrel, then realizing a radial extension and/or a fold-up of a determined portion of the thus produced preform profile; and

a device for applying a polymerizable resin over the preform to produce therefrom the revolving part.

According to other form, the present disclosure also relates to revolving parts at least one layer of which has been obtained with the method of the present disclosure by means of the manufacturing facility of the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 represents a portion of a part achievable with the method of the present disclosure;

FIGS. 2a to 2c represent a plurality of sections of parts achievable with the method of the present disclosure;

FIGS. 3a to 3h represent other examples of shapes of sections achievable with the method of the present disclosure;

FIGS. 4a and 4b represent two fabric layouts during the step of rolling up a fabric on a mandrel in a facility for manufacturing preforms according to the present disclosure;

FIGS. 5a to 5e represent subsequent steps carried out in a facility for manufacturing preforms according to the present disclosure;

FIGS. 6 and 7 represent the steps of modeling a preform to be obtained and of transformation to deduct therefrom the shape of the associated mandrel in a first form of the method of the present disclosure;

FIGS. 8a, 8b, 9 to 10 represent the steps of modeling a preform to be obtained and of transformation to deduct therefrom the shape of the associated mandrel in a second form of the method of the present disclosure; and

FIGS. 11 and 12 represent the steps of modeling a preform to be obtained and of transformation to deduct therefrom the shape of the associated mandrel in a third form of the method of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

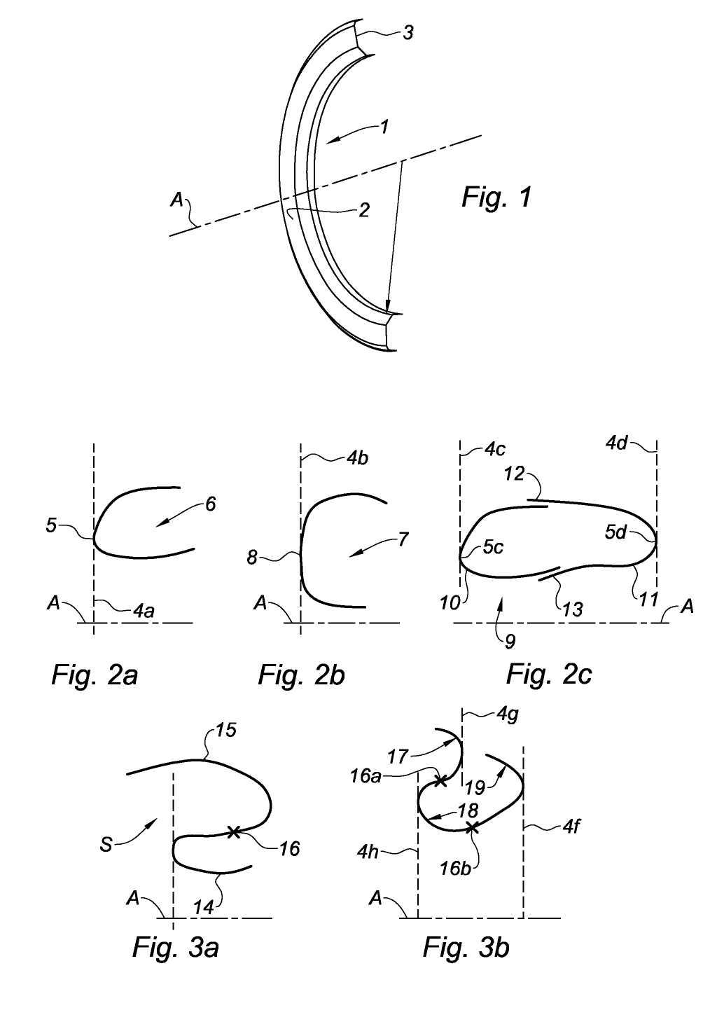

In the figures, the same reference numerals relate to the same elements which are described hereinafter. In FIG. 1, there is represented a portion of a composite material part realized with the method of the present disclosure. Such a part 1 exhibits a symmetry of revolution about the axis A. Its lower portion 3 includes two lateral flanges joined together by a connection portion 2 a line of which represents the roll-over point of its radial section. For a coordinate measured along the axis of revolution A of the part 1, no point of the section of the part extends beyond the marked line on the portion 2.

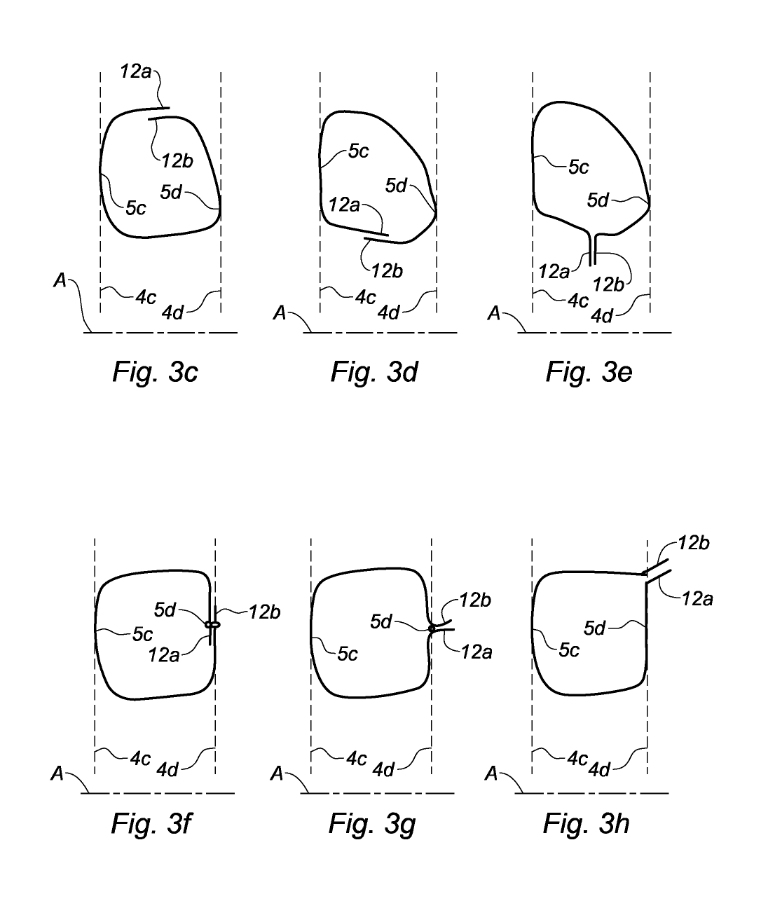

In FIGS. 2a to 2c, 3a and 3b and 5b, there is represented a schematic half-view of the section of each revolving part about its axis of revolution A, which has been represented as one form of the present disclosure. In FIG. 2a, there is represented such a section of a hollow or <<C>>-shaped revolving part 6 about the axis A and which exhibits two connected flanges which contact a radial tangent line 4a at a roll-over point 5 of the section.

In FIG. 2b, the <<C>>-shaped hollow part 7 exhibits a broader contact area 8 with the radial tangent line 4b.

In FIG. 2c, the composite part exhibits a closed section 9. It is realized from two <<C>>-shaped hollow parts 10 and 11. Each hollow part 10 or 11 exhibits at least one roll-over point or contact area 5c or 5d along a line of larger spacing respectively 4c and 4d, each line 4c or 4d constituting a radial tangent line for the hollow part 10 or 11 corresponding thereto. During the manufacture of the hollow parts 10 and 11 according to the method of the present disclosure, the homologous edges 12 and 13 of the preforms of these hollow parts 10 and 11 are joined to each other, edge-to-edge, or as in this case, by overlapping.

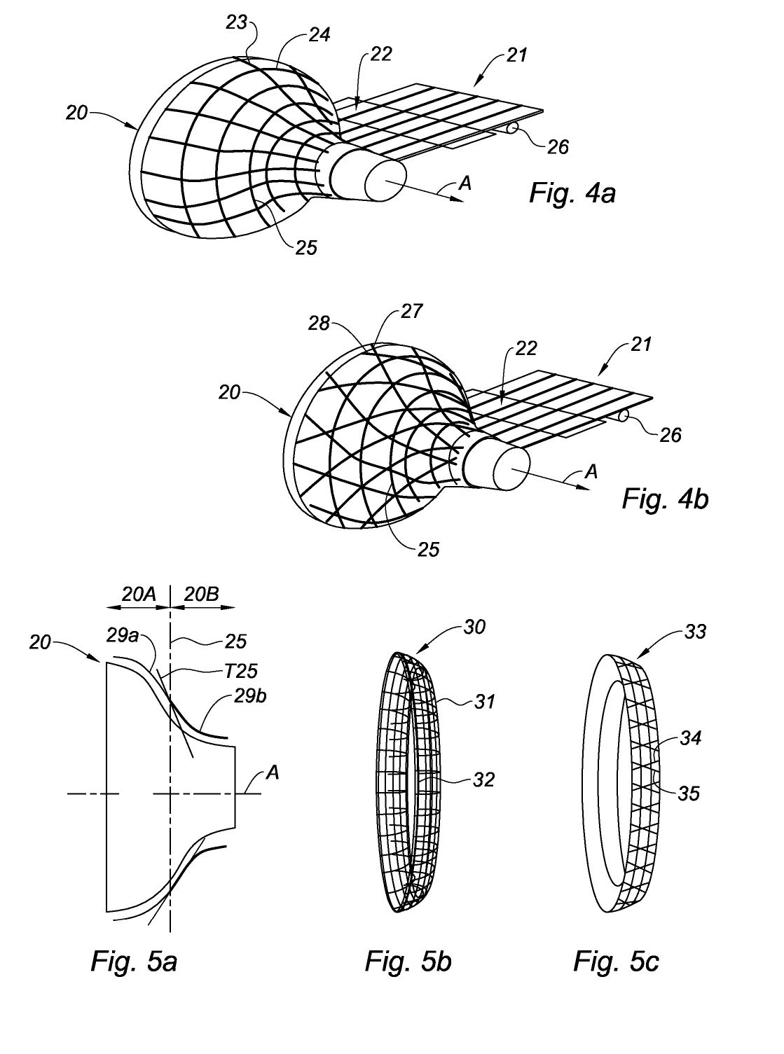

In FIG. 3a, there is represented the section of a composite material part 14, 15 with an <<S>>-shaped current section, according to another geometry. The part 14, 15 is composed of two C-shaped hollow parts, each one being similar to the hollow part 6 of FIG. 2a or to the hollow part 7 of FIG. 2b. The <<S>>-shaped current section of the part 14, 15 is thus composed of two areas with a <<C>>-shaped section 14 and 15 having opposite concavities and which are connected at the junction point 16. The junction point 16 can be realized according to the two modalities described for the junction bridges 12 or 13 of the parts 10 and 11 of the form of FIG. 2c. The S-shape of the part is eventually the concatenation of two C-shapes. The part having an S-shaped section is realized with fabric-made preforms in one piece which are realized with the method of the present disclosure.

In FIG. 3b, there is represented the open section of a composite material part 17-19 realized according to the method of the present disclosure. The part 17-19 is <<W>>-shaped in its current section. It consists of the concatenation of multiple <<C>>-shaped sections, each one being similar to the hollow part 6 of FIG. 2a or to the hollow part 7 of FIG. 2b. The various <<C>>-shaped sections do not interfere with each other. Each hollow part 17, 18 or 19 is produced according to the method of the present disclosure so that no point of its section exceeds the radial tangent line 4h, 4g or 4f respectively. The hollow parts 17 and 18 connect at the junction point 16a, the hollow parts 18 and 19 connect at the junction point 16b, the junction points 16a or 16b being similar to the one 16 described in FIG. 3a.

In FIGS. 3c, 3d, 3e, 3f, 3g, 3h, there are represented closed sections of toroidal parts realized according to the method of the present disclosure. These sections of toroidal parts include two extreme generating lines. The method of the present disclosure performs, in the same way as before, the draping in one piece of the total toroidal surface of the part. The closing of the section is obtained edge-to-edge or by overlapping as disclosed in the figures.

In FIG. 3c, which as FIGS. 3a to 3h is a schematic half-view, the revolving part about the axis A is manufactured with two limit points 5c on the normal plane 4c and 5d on the normal plane 4d. The two normal planes 4c and 4d are considered relative to the axis of revolution A of the thus manufactured part. The edges of the drape of the preform are placed by overlapping the edges 12a and 12b disposed outside (upwardly in FIG. 3c) of the revolving part which is then obtained by impregnating the preform.

In the following figures, the same elements as those of FIG. 3c have the same reference numerals and will not be described again. However, the particularities of the figures are:
in FIG. 3d, the overlapping of the edges 12a, 12b is performed inside, directed toward the axis of revolution A;
in FIG. 3e, the edges 12a and 12b are disposed edge-to-edge inside the part, directed toward the axis of revolution A;
in FIG. 3f, the overlapping of the edges 12a and 12b is performed on one side of the revolving part, and is located on the limit point 5d on the normal plane 4d of the part;
in FIG. 3g, the edges 12a and 12b are disposed edge-to-edge on the limit point 5d; and
in FIG. 3h, the section of revolution of the part assumes a substantially quadrangular shape and the edges 12a and 12b are placed edge-to-edge on one corner of the part outwardly relative to the axis of revolution A.

All these parts are manufactured with drape-made preforms which are realized with the method of the present disclosure.

The manufacturing method of the present disclosure takes place in three separate phases. During a first phase, the design of the part, the calculation of the geometry of the drape-made preform and the calculation of a mandrel of forming of a first manufacturing state of the preform, are carried out at the same time. During a second phase of the method of the present disclosure, the facility for manufacturing the preform is configured by associating the previously calculated mandrel to the device for manufacturing the drape. The drape is realized and rolled up on said mandrel as it is manufactured. During a third phase, the preform is extracted from its mandrel in order to apply thereto a determined geometric transformation which makes it pass from a first manufacturing state to a second and last manufacturing state. Finally, the preform is held in this geometric manufacturing state on the adapted tooling and the impregnation of the preform with a resin and its curing are carried out in order to obtain the desired composite material part.

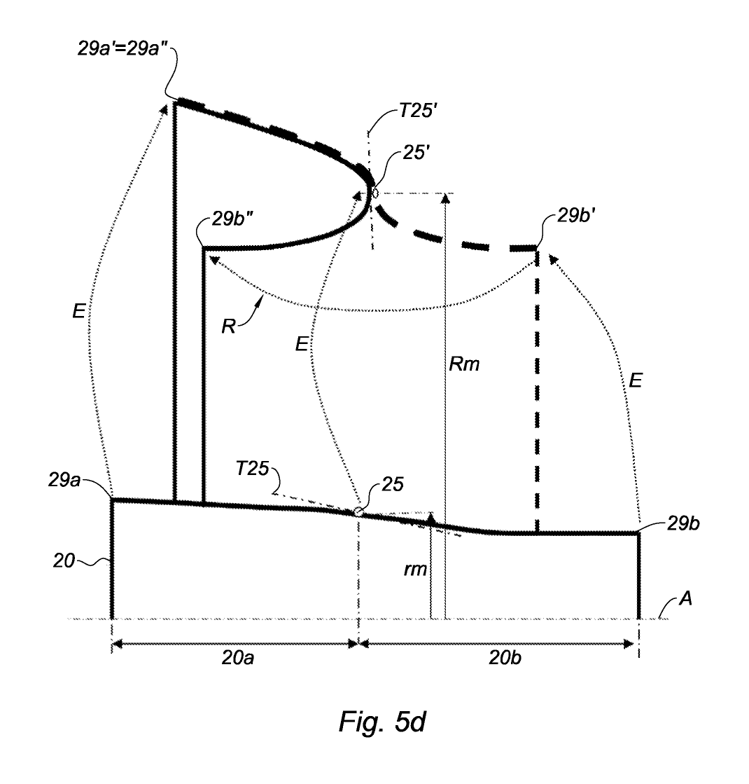

In FIGS. 4a and 4b, there is represented a step of the method of the present disclosure during the second phase of its realization comprising carrying out the weaving or braiding of the rolled up preform on or around the weaving or braiding mandrel.

In FIG. 4a, the drape is a fabric which exhibits, once rolled up around the mandrel 20, a determined layout of substantially orthogonal warp yarns 24 and weft yarns 23 and which depends on the preform and/or the revolving part that is desired to be produced with the method of the present disclosure. The fabric drape which rolls up on the mandrel 20 is produced in a weaving machine not represented in the drawing and which is disposed to the right and comprising, in particular, a device for tensioning the warps 21 and for distributing tensions in the drape frame so as to assist its rolling up around the mandrel 20, and a mechanism for inserting the weft yarn 22 which injects with controlled angles the weft yarn on the fabric drape 21. As has been specified above, the layout of the drape containing the warp yarns 21, the control of the insertion of the weft yarn in the weft weaving mechanism 22 and the geometry of the mandrel 20 have been calculated during the first phase of the method of the present disclosure and which will be described later. Note the particular warp yarn carrying the reference numeral 25 in the drawing, and which corresponds to an inflection point or a roll-over point, on the contour of the mandrel 20. Its role will be detailed later.

Note that, since the drawings represent only but a section of the preform, the warp yarn 25, and any other element that replaces it according to the type of drape used as will be described later, is represented and described as a point, because the warp yarn or any other similar element is represented by a point in the section represented in the drawing. Similarly, the point 25 is defined on the drape of the preform. When the drape is rolled up around the mandrel 20, the point 25 coincides with the homologous point of the mandrel 20 and no other reference numeral is used in order to simplify the drawing and because the shape of the mandrel is determined by the calculated shape of the preform that the mandrel is intended to produce.

Note that the layout of the drape is determined in particular by the choice and the relative arrangement of the warp yarns and the weft yarns, in particular in terms of surface density and number of layers.

The rolling up of the drape takes place on a portion or the totality of the circumference of the mandrel 20, in one or several layer(s).

For realizing such a fabric, control of the layout of the drape and the choice of the shape or profile of the mandrel 20 uses a set of determined rules in order to preserve the quality of weaving along the roll-up around the mandrel. Among these control rules, note:
approaching the weaving point to closest to the mandrel,
or, completing the shape of the mandrel beyond the usable width with a reduced or an increased shape according to the current area, to keep the warp yarns aligned and parallel.

In FIG. 4b, there is represented the same second phase of the manufacturing method of the present disclosure, in the manufacturing state of FIG. 4a, but in which the weaving of FIG. 4a is replaced with a braided drape or a braid in which weft yarns 27 and 28 are intertwined around a direction perpendicular to the warp yarn 21 at angles determined by the layout of the fabric calculated during its first phase of the method of the present disclosure. The same warp yarn 25 type is found at an inflection point of the contour of the mandrel 20 and the same arrangements for realizing the preform as in FIG. 4a, may be taken.

In this case of braiding, the orientationd of the weft yarns 27 and 28, result from the combinations of displacements of these yarns along the width of the mandrel in relation to the rotational speed thereof during the braiding operation. Hence, the courses of the yarns depend on the geometry of the mandrel, and we cannot necessarily obtain a perfect symmetry and at every point of the mandrel of the positive and negative orientations of these weft yarns.

Thus, on completion of the execution of the method in the state of FIG. 4a or 4b, a fabric- or braid-made preform is obtained in a first manufacturing state.

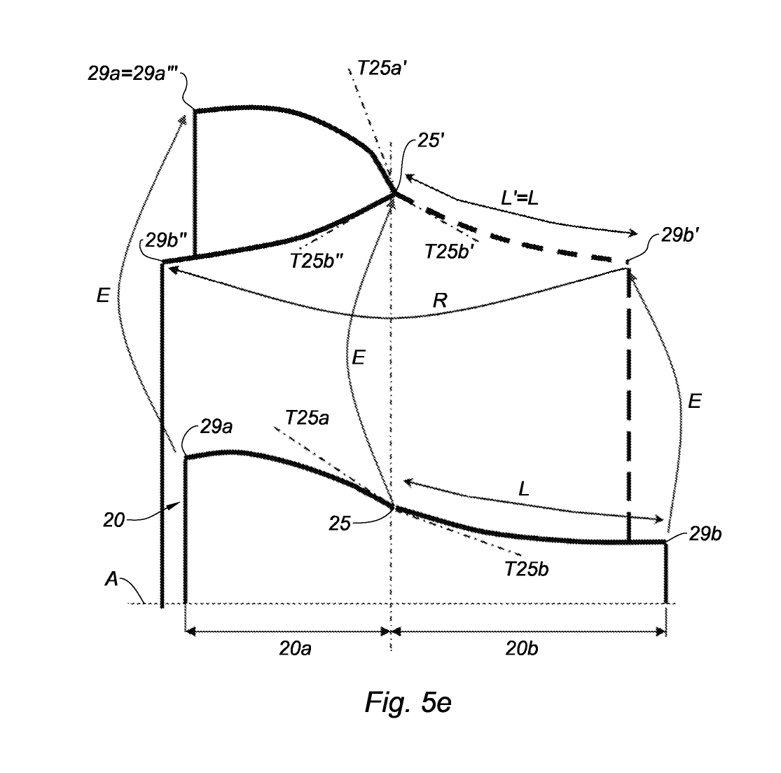

In FIG. 5a, there are represented the operations of the second phase of the method of the present disclosure for a part type of which section includes a radial tangent, during which a second manufacturing state of the preform is produced. The warp yarn 25 is in a plane which divides the mandrel 20 into two portions 20A and 20B on either side of the inflection change plane of the profile of the mandrel. Thus, the point 25 is an inflection point of the lines described by the weft yarns or by the plot of a cross-section of the preform on the mandrel. The inflection is marked by the tangent T25 which is local on the intersection of the mandrel and of the plane which divides the mandrel 20 into two portions 20A and 20B. The directions of the wefts, when they are installed perpendicularly to the warp yarns, follow the generating lines 29a, 25 and 29b.

In FIG. 5b, there is represented the woven drape-made preform of FIG. 4a when it has been shaped into its second manufacturing state on completion of the operations of FIG. 5d for a 360° revolving shape. The warp yarns 32 of the woven drape are disposed substantially along circles centered on the axis of revolution (not represented) of the preform 30, whereas the weft yarns 31 consist of curves determined in radial sections relatively to this axis of revolution. It is then possible to carry out the impregnation of the preform with resin.

In FIG. 5c, there is represented the braiding preform of FIG. 4b when it has been shaped in its second manufacturing state on completion of the operations of FIG. 5d. The warp yarns are substantially disposed along circles centered on the axis of revolution (not represented) of the preform 33, whereas the weft yarns 34 and 35 are curves that are determined and tilted relatively to radial sections relatively to this axis of revolution.

In FIG. 5d, there are represented the geometric transformations successively applied to the preform to bring it from its first manufacturing state to its second and last manufacturing state. Thus, in the form of FIG. 5d, the drape-made preform, in a first manufacturing state, is first deployed from the mandrel along a radial extension E, bringing the point 25 with a carrying radius rm or mandrel radius, to the point 25′ with a final radius Rm required for the part obtained from the preform in its final manufacturing state as will be explained later. The preform then assumes a revolving shape of which the sections or the generating lines are <<S>>-shaped along the contours 29a′-25′-29b′. The point 25 of the drape on the mandrel 20 then passes from the radius rm to the radius Rm by the extension Eon the point 25′ the tangent T25′ of which has rotated as a result of the extension E at most in the plane normal to the axis A of the mandrel 20.

A geometric transformation R is then applied on the second portion 20b of the first manufacturing state of the preform on the mandrel 20, which has been enlarged by the extension E along the profile 25′-29b′. Said second portion 20b of the first manufacturing state of the preform is comprised between the inflection or roll-over point 25′ of tangent T25′ and the end 29b′ of the extended drape to the right in the drawing. The second transformation R includes in particular a translation parallel to the mandrel axis, so as to bring the extended second portion 25′-29b′ in the position 25′-29b″, so that the preform is located in a second and last manufacturing state 29a″-25′-29b″. The transformation R may be understood as a folding of the second portion 25′-29b′ of the drape of the preform which achieves its production or manufacture itself. This transformation R, executed during the third phase of the manufacturing method of the present disclosure, is opposite to the unfolding step which has been determined beforehand during the first phase of design of the part. This unfolding is purely virtual in that it involves only a portion of the section of the calculated preform and not the manufactured preform. This virtual unfolding allows calculating the geometry and the layout of the drape of the preform and allows calculating the mandrel 20 of forming of a first manufacturing state of the preform.

In FIG. 5e, there are represented the transformations which are applied for a shape of which the extreme generating line does not constitute a radial tangent but may be regarded as an angular ridge. For such a shape, on the mandrel 20, the wrap 25 position will be characterized by two half-tangents T25a and T25b pointing respectively toward 29a and 29b. The drape from the mandrel 20 is deployed along a limited extension E to the final radius value corresponding to the wrap 25′, with the half-tangents T25a′ and T25b′ respectively toward 29a′ and 29b′. The geometric transformation R transposes symmetrically to the plane of the generating line 25′, the drape portion from 25′-29b′ to 25′-29b″. Note in particular that, in this form, the second portion 25-29b of the preform is subjected to an extension E in order to pass from the first manufacturing state 25-29b on the mandrel 20 to an intermediate manufacturing state 25′-29b′, so that the curvilinear lengths of the drape elements composed by the braided weft and warp yarns are preserved. This manufacturing constraint and others, alternative or not, will be more fully defined later. The folding R is then applied, as in the form of FIG. 5d, but in such way that the second portion 25′-29b′ of the extended preform is unfolded in 25′-29b″ while following a half-tangent T25b″ which forms a determined angle, less than 180° with the half-tangent T25a′, and to the left of the plane normal to the axis A of the preform and of the mandrel 20 and which passes through the drape points or elements 25 and 25′. The extended and folded preform 29a″-25′-29b″ is then into its second and last manufacturing state. The thus manufactured preform exhibits an angular ridge in 25′ which constitutes the most extreme point of the preform behind the plane normal to the axis of revolution A of the preform.

In this second and last manufacturing state, the preform properly held on a forming tooling may be further finished:
by superimposing continuous layers of fabrics or braids obtained by the method,
by adding local reinforcements pieces,
by inserting a non-structural filling material such as a filling foam, or
by any other supplement usually realized according to the composite methods.

The whole drape, shaped, transformed, and/or provided with the aforementioned supplements, is installed in a tooling adapted to a chosen consolidation method in order to finish the preform of the present disclosure. Then, the impregnation of the preform with resin and the curing of the latter are carried out in order to stiffen the structure. Thus, one of the parts described for example in FIGS. 2a-2c and 3a-3g is obtained.

The facility for manufacturing revolving composite material parts of the present disclosure provides the means for implementing the three main phases of the above-mentioned method. The facility includes a device for calculating a layout of a fabric on the basis of a given shape of a revolving part to be realized in a composite material and at least one mandrel for realizing a fabric-made preform of said revolving part. This device includes at least one CAD computer equipped with a software executing the method of the present disclosure, or at least one device for geometric description and geometric plotting of the shapes. The installation then includes a device for realizing a fabric reproducing the determined fabric layout. The weaving or braiding facility comprising the device for taking up the weaving and rolling up around mandrels manufactured based on the dimensions calculated during the first phase of the method. Of course, such a weaving or braiding device can be made available by a supplier and its product be stored and transported for the rest of the method of the present disclosure. The facility then includes a mechanism for deploying the weaving from the building mandrel, until the final shape by applying the different transformations E and R previously described. This device can also include cutting means, means for securing the layers with each other or with local reinforcements. The facility then includes a device for applying a polymerizable resin over the preform to produce therefrom the revolving part.

In the following figures, the first phase of the method for manufacturing composite parts by preforms according to the present disclosure will be described.

In this first phase of the method for manufacturing parts, a calculation should be carried out to determine at the same time the desired part, then deduct therefrom the layout of the woven or braided fabric that can be used and the profile of the mandrel to produce the first shape of the preform adapted to the desired part. Finally there should be determined the geometric transformation which allows realizing the expansion and the turning-over or folding of the preform from its first manufacturing state (when it is still rolled up on its mandrel 20) in its second manufacturing state, just before the resin impregnation operation,

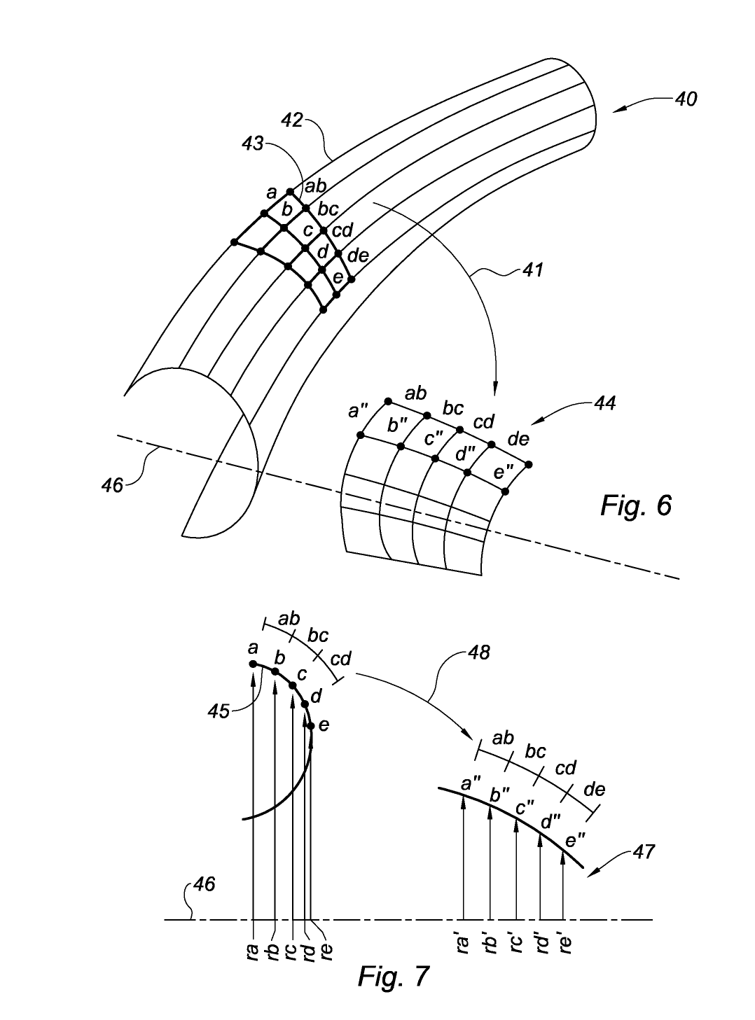

In FIGS. 6 to 12, there are represented the various implemented calculation techniques, in which, the surfaces of the part are cut into meshes according to rules which will be detailed below, and the braiding or fabric drape will follow these same transformations during the different steps of the method which have been previously described.

Thus, in FIG. 6, there is shown the topology of a surface of the part, the preform or the mandrel covered by curves of profile designated by the points of the meshes. A profile includes a plurality of points (a, b, c, . . . ) to which, an indicia i from 1 to n is assigned, if appropriate, to describe the n curved profiles of the final part, the preform and/or the mandrel. To define the geometric transformations which allow passing from the part to the mandrel, or to either of the two states of the preform, notations of the type (a, b, c, . . . ) or (a′, b′, c′, . . . ) or finally (a″, b″, c″, . . . ) are used.

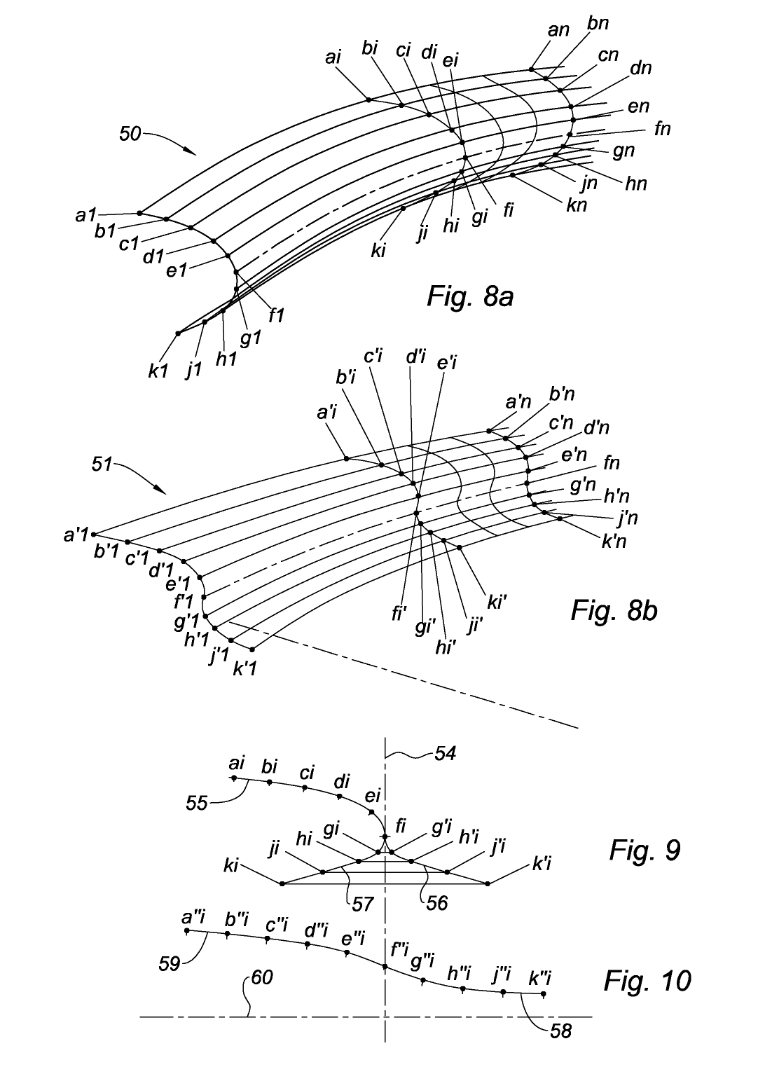

FIG. 8 shows the meshing continuity during the turning-over corresponding to the phase R. The surface meshed according to the curved profiles (a,b,c,d,e,f,g,h)i may be firstly returned into a surface meshed according to curved profiles (a′,b′,c′,d′,e′,f′,g′,h′)i by axial symmetry relative to the point f which exhibits an extreme abscissa. Thus, for example, a=a′, b=b′, c=c′, d=d′, e=e′, f=f′, g=−g′, h=−h′.

The point 25, mentioned in FIGS. 4a and 4b, is hereby explained. In fact, this point 25 corresponds to the point f of each profile.

On the thus obtained surface, a same radial homothety factor with a modulus strictly positive and smaller than 1, is applied for each circumferential generating line. In one form, the radial homothety factor is such that, for all the generating lines (a′i, b′i, . . . ), compatible radii of mandrels for rolling up fabric are achieved, namely typically diameters comprised between 50 mm and less than 300 mm. But we can also have diameters comprised between 200 and 800 mm for example depending on the dimensions of the final part. Hence, it is common to have coefficients ranging from 0.1 to 0.3.

The reduced generating lines (a″i, b″i, c″i, . . . ) are spaced apart at distances so as:
ab=a′b′=a″b″,
bc=b′c′=b″c″,
etc . . .
these distances being observed in curvilinear abscissa along considered profiles i.

On this defined mandrel surface, the textile, which comes out properly textured by the aforementioned weaving machine, is rolled up. The mandrel having a non-cylindrical “toroidal” shape, the fibers are differentially pulled (or taken up) by the mandrel along the width of the loom. Hence, the preform is created by a textile which conforms to a non-developable shape, namely, the shape of the mandrel, or the shape of the previous layer already rolled up on the mandrel if several turns are rolled up on the same shape.

This method, which has been described for a shape called <<C>>-shape, may also be applied for an <<S>>-shape. For the <<S>>-shape, we consider that it consists of two <<C>>-shaped curves which touch at an opposite end of the <<C>>-shape, and we apply, for each <<C>>-shaped part, the method previously described. Two separate axial symmetries will be then applied on each one of the two ends of the final <<S>> on either side of the central area, and a common and single homothety with a positive coefficient smaller than 1 will be applied to the entire two areas.

For a part shape with a <<W>>-type section or more, as well as for <<O>>or <<D>>-shaped sections, the number of axial symmetries is multiplied as many time as there are roll-over points along the profile.

The methods applied by those skilled in the art to realize what is called contour weaving, (or capstan contour weaving—or capstan contour braiding in the case of braiding) may be applied, such as:
providing several successive mandrels with adapted shape,
providing counter-rolls, etc . . . , to pull the weaving from the loom, before rolling up the weaving on a roll, while arranging a low tension on the latter, in order to preserve over a wide length of weaving, the same geometric shape defined by the fabric take-up mandrel,

The provided solution is particularly suitable for the toroidal or substantially toroidal geometric shapes. Particularly, the shapes described in FIGS. 1 to 3 may be used.

The method of the present disclosure for defining the mandrel is described hereinafter in another form, but with the same objective.

Consider a <<C>>-shaped geometric shape about an axis of revolution, a fabric layer covering a portion of the surface, may be generically defined as a point of the surface, and have an axis of fibers called circumferential fibers, and an axis of fibers called transverse or radial fibers. The use of the transposition at weaving will be to associate the weaving warp yarns to the circumferential fibers, and the weft yarns to the transverse fibers. The transposition in the case of braiding will be explained later.

The transverse fibers have a defined angle relative to the circumferential fibers, which is not necessarily equal to a 90° angle.

From this initial <<V>>-shape, or this ‘rosette’, quadrilaterals that preserve sides having the same ratio between the longitudinal (circumferential) direction and the cross (radial) direction, are gradually generated over the entire surface of the part.

If the part is with a constant section and revolving, for one layer, in each plane of revolution, a perimeter length corresponding to the length of the circumferential fibers required to perform a complete turn, is thus described .

For two planes in the vicinity of this surface, the part surface may thus be assimilated to a cone.

Since this cone exhibits a large carrying diameter, and in order to facilitate its weaving on a weaving loom, it is envisaged to reduce the diameter to an order of magnitude of 30 to 300 mm of radius. Thus, a homothety factor is defined between the considered cone of the part, and the required mandrel cone.

Gradually, it is preceded in a similar way for the entire section of the part.

Thus, the area where the section of the part is tangent to a radial plane is reached. The discretization of this surface thus constitutes a disc ring which, according to the selected reduction homothety factor (<1), is hence transformed into a cone section, according to the same rules (the same homethety ratio for the different circles, maintenance of the distance between the points of the two circles).

Beyond this plane where the points have a radial tangent, the same principle is continued, but instead of returning backward along the abscissa axis parallel to the axis of revolution, these points are transposed according to a planar symmetry, with a plane orthogonal to the axis of revolution and containing the radial tangent point.

In the light of what has been described above, we understand how to obtain a warp-and-weft woven textile of which the warps will be disposed along circumferences on the mandrel and hence on the final surface, generating lines (a″i, b″i, . . . ) on the mandrel corresponding to generating lines (ai, bi, . . . ) on the final shape. The wefts are disposed longitudinally to the mandrel and hence radially to the final surface, the mandrel profiles (a″b″c″d″. . . k″) corresponding to the profiles (abcd . . . k) on the second and last state of the preform.

For the weaving pattern of the initial warp-and-weft two-dimensional fabric, all the fibers that are usually used to realize textile shapes may be used, and in particular those used to realize fabrics for parts made of composite materials of glass fibers, carbon fibers, Kevlar fibers or ceramic fibers.

Similarly, all usual weaving patterns, such as the taffeta pattern—or plain, the twill patterns, the satin patterns and any derived or hybrid patterns, may be used.

However, in particular in the areas close to the generating lines for turning over the surface as the area around the plane 25 containing the inflection points of the mandrel (FIG. 5a), we will preferably use patterns of which shrinkage of the fibers is symmetrical in thickness, in order to avoid the weaving distortions during the turning-over.

In fact, when turning over the surface, in the curvature reversal area, the fibers, in particular the weft ones, will be caused to slide over one another and relative to the warp yarns due to the changes in the unit length, and in the case of a weaving pattern with a symmetrical shrinkage in thickness, such as a plain or a 2×2 or 3×3 twill, the different weft fibers have an identical length when the course is considered with the shrinkage. Upon turning over, there is thus no fiber exhibiting an excessive tension relative to the other.

This arrangement will be particularly recommended the more the curvature radius in the proximity of the point 25 of the section profile will be low, and even zero (case of the shape with an angular point according to FIG. 5e).

The concept, developed above for a warp-weft fabric may also be applied to a braiding, either biaxial according to positive and negative angles around the axis, or triaxial, and hence the third direction corresponding to the woven texture warps will roll up around the mandrel. The principle of transposition of shapes and textures remaining the same, the density and the orientations of the braid on the mandrel depending of the braiding devices upstream of the mandrel and of the diameter evolution of the mandrel.

The principle that has been exposed above applies in a very correct manner, if only one layer of fabric is considered and even when using, for the shape transposition, the surface corresponding to the mid-thickness of the fabric instead of the molding surface.

To reach this level of perfection, hypotheses should be emitted as to the surface density of the fabric which will be created by weaving. In fact, the local surface mass depends on the count of the used yarns (count=mass in grams per kilometer of yarn), the warps pitches (which may be variable along the width) and the weft pitch which is a function of the local diameter of the mandrel, because, theoretically, the wefts are installed along generating lines of the mandrel and hence the spacings between the wefts vary depending on the local diameter (along the mandrel, there is an identical number of wefts for the same angular sector of the mandrel).

This variable surface mass being established, and depending on the density of the material and its volumetric distribution, a virtual surface corresponding to the mid-thickness of the intended braiding will be created.

It is on this surface that the turning-over or partial symmetry/symmetries and homothety process is then applied. The virtual neutral surface of the fabric on the weaving mandrel is thus obtained.

The surface of the weaving mandrel is then deducted from the previous virtual surface by removing the fabric mid-thickness depending on its local surface density.

The manufacturing method of the present disclosure also applies for parts constituted of multiple layers of fabrics, which is very often necessary. It is observed that, for thicknesses of parts relatively low relative to the radii of the final parts, for example for a 10 mm thick part the generating lines of which are on carrying radii of at least 500 mm, the distortions of the lengths of the fibers resulting from the use of a same fabric defined on a mandrel, to realize the different layers, are low and absorbed by compaction of the layers before impregnation with resin, which allows simplifying the industrialization of the fabric. Hence, a simplified method may be applied consisting in applying the method to the surface corresponding to one single layer and realizing a same fabric for all layers. In one form, the surface corresponding to the mid-thickness of the part according to the acceptable degree of distortions, may be used.

The method described above, allows defining the mandrel and weaving the fabric to realize a fabric disposed along substantially orthogonal orientations when the fabric is viewed on the part surface.

As a consequence, a textile thus designed offers only two main directions of fibers.

This limitation is sometimes penalizing when it comes to withstanding mechanical stresses to which such a part may be subjected. For example, such a geometry may be often subjected to torsional stresses, for which it is preferable to be able to provide at least one portion of the fibers disposed at helically angles and alternating positively and negatively about the axis of revolution.

For this purpose, it is possible to employ a combination with a braiding technique which has also been described above, or employ only but one braided textile structure, however it may use a woven texture of which the production costs as well as control of the angles are often lower than braiding.

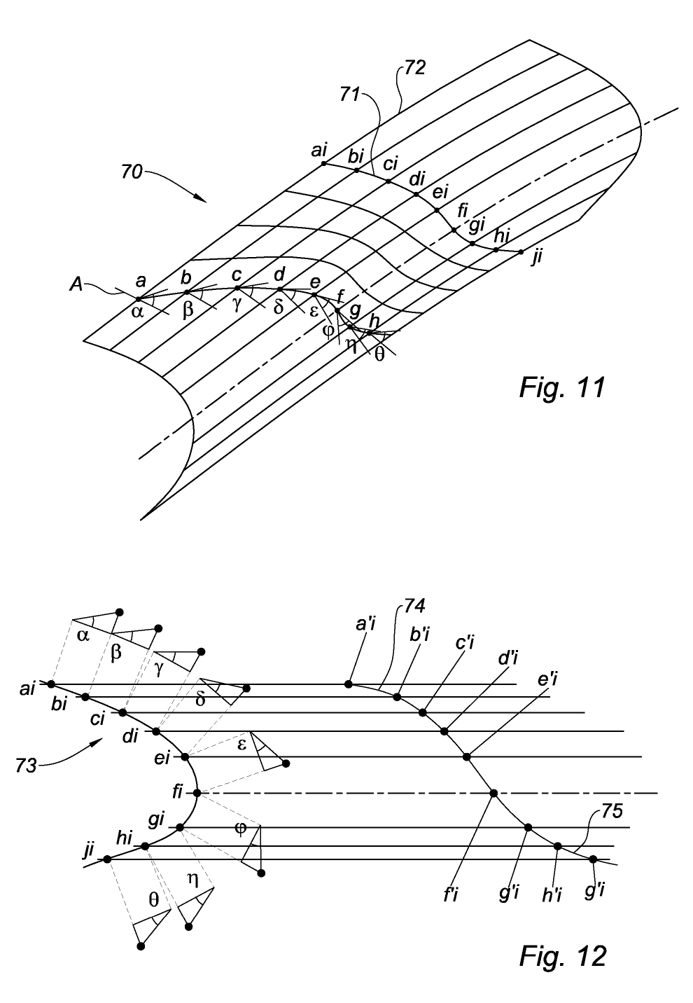

To achieve these results, the method illustrated in FIGS. 11 and 12 is applied. Hence, it should be considered that, on the final shape, the weft fibers of the weaving will have an angle different from 90° with the warp fibers whereas when weaving, we have naturally created such a 90° angle. The transposition between the mandrel and the final shape is done by changing the distance formulation between the different circumferences of the mandrel relative to the part surface.

The principle to be adopted amounts to considering a quadrilateral meshing of the surface of the part, in which, the circumferential generating lines (ai, bi, ci, . . . ) correspond to the circumferences of the different warps of the weaving to be obtained, and for which are successively applied the steps of surface turning-over (symmetry) and diameter reduction; and the segments ab, bc, cd, . . . are oriented so as to follow the desired orientation in each region of the surface, the segments a″b″, b″c″ having lengths equal to the segments ab, bc, . . . . defined on the corresponding surface on the mandrel are disposed along a plane parallel to the axis of the mandrel.

Weaving being carried out orthogonally, during the deployment for draping of the part, deframing of the fabric in shape should be carried out, in order to properly cover the surface, the weft yarns will then follow the profiles (a, b, c, d, h) at the angles α β γ . . . defined as shown in FIG. 11.

An almost angularly symmetrical draping set may be obtained by alternately deframing the successive layers of the stacking along a positive or negative direction. If different angles are desirable for different layers, they will require, for a same part surface, as many mandrels with different profiles.

All the methods described above are particularly suitable for realizing textile preforms for the realization of structural parts in composite materials depending on their geometry and according to direct impregnation methods such as RTM (Resin Transfer Moulding), vacuum infusion LRI, infusion with resin films (RFI Resin Film Impregnation), wet impregnation, and their different derivatives.

Mention may be made to parts such as <<C>>-shaped revolving profiles (FIGS. 2a, 2b), <<S>>-shaped revolving parts (FIG. 3). Parts having closed sections may also be realized by this method, covering of the surface of the part being obtained by different decompositions of the shape either into two <<C>>-shaped portions (FIG. 2c) or into one single portion by opening the shape (FIGS. 3c-3g).

In FIG. 6, there is represented a revolving surface with an axis 46 representing a portion of a part 40 to be manufactured. A meridian (a, b, c, d, e, . . . ) along a weft yarn of the preform 43 has been represented while undergoing a geometric transformation which makes the surface 40 pass into a transformed surface 44 which represents the mandrel. In the transformed surface 44, the meridian (a, b, c, d, . . . ) of the meshed surface 40 has been transformed into a meridian (a″, b″, c″, . . . ) on the mandrel surface 44 by a homothety with a determined factor over the angles intercepted by each one of the profile arcs ab, bc, cd, . . . Referring to FIG. 7 where the meridian sections 45 of the part or the preform 40 (FIG. 6) and 47 of the mandrel 44 (FIG. 7) have been plotted, it results from the preceding that the geometric transformation 41 or (48, FIG. 7) is executed while complying to one or several constraint(s) according to which the elementary surfaces of the meshes of the part and/or the preform with those of the mandrel are preserved and which includes:

preservation of the perimeters of the elementary meshes by applying a homothety having a coefficient which is unique to all the generating lines with a constant ratio of the radii ra/ra′, rb/rb′, . . . measured between the current point a of the mesh on the meridian and the axis of revolution 46;

spacing apart the generating lines so that the curvilinear distances (ab, bc, cd, . . . ) between the points of the mesh along the profile (a, b, c, . . . ) remain identical on the transformed profile (a′, b′, c′, d′, . . . ) and the transformed profile (a″, b″, c″, d″, . . . ).

FIGS. 8a, 8b, 9 to 10 represent the steps of modeling a preform to be obtained and of transformation to deduct therefrom the shape of the associated mandrel in a second form of the method of the present disclosure.

The shape of the part to be obtained or its fabric-made preform 50 is partially represented in FIG. 8a with its meshing by the warp yarns and the meridian lines here aligned on the weft yarns. The meshing points (a, b, c, . . . ) are repeated with current indicia i from 1 to n and the points (fi) are disposed on a warp yarn representing an extreme of the points of the part or the preform 50 along its axis of revolution.

In FIG. 8b, there is represented the meshing deducted by the above-described geometric transformation and defined by the points of the current meridian (a′i, b′i, c′i, . . . ). The points (f′i) along the shape 51 will correspond to inflection points on the first state of the preform on its mandrel (see the plane 25, on the mandrel 20, FIG. 5a).

In FIG. 9, there is represented a section of preform in that it locates in one of the two states respectively 55, 56 for the first unfolded state, and 55, 57 on its final rolled up shape, corresponding to the reference numerals respectively 50 and 51 of FIGS. 8a and 8b.

In FIG. 10, there is represented, aligned on the extreme plane 54 of the points of the preform 55, 57 in its second state, the revolving profile of the mandrel with the meshing points (a″i, b″i, c″i, . . . ) distributed into two portions 59 and 58 on either side of the plane 54 which marks the inflection point f″i of both the mandrel and the preform in its unfolded state 55, 56.

FIGS. 11 and 12 represent the steps of modeling a preform to be obtained and of transformation to deduct therefrom the shape of the associated mandrel in a third form of the method of the present disclosure.

In FIG. 11, there is represented for a part to be produced with its preform 70, several weft yarns 71 belonging to a framing on warp yarns 72 with a determined angulation during the manufacture of the fabric and determined during the design of the preform. By choosing a common reference direction A, the angle with the reference direction is measured for each point of the meshing, namely the angle α for the curvilinear segment ab, the angle β for the curvilinear segment bc, etc.

The initial meshing is established according to the thus tilted profiles (ai, bi, ci, di, . . . ) relative to the normals of the circumferential lines.

The surface meshed with the profiles (a′i, b′i, c′i, . . . ) is established by spacing apart these profiles so that the distances a′ib′i=aibi.

The angles δγβα . . . should be smaller than the deframing capability of the fabric to be produced (generally less than)35° , it is desirable to not change too much the angles along the profile which would make the setup on the shape more delicate.

In FIG. 12, there are represented, in correspondence, a profile 73 meshed by the series of points (ai, bi, ci, . . . ) and the derived mandrel profile 74, 75 with the points (a′i, b′i, c′i, . . . ). Note the inflection point f′i which will correspond to the turning-over R or folding plane (see FIG. 5a).

The present disclosure includes, in addition to what is specifically claimed, the following features:

The method includes the choice of symmetrical weaving patterns for covering the two faces of the drape, such as plain or twill weaves.

The method also includes a step of deframing the fabric in at least one portion of the drape.

In the method, in order to facilitate weaving on a weaving loop, it is provided that the diameter is reduced to an order of magnitude of 30 to 300 mm of radius by a homothety having a homothety factor between the considered cone of the part, and the required mandrel cone.

In the method, for weaving the initial warp-and-weft bi-dimensional drape, weaving patterns, such as the taffeta pattern—or plain, the twill patterns, the satin patterns and any derived or hybrid patterns, are used.

In the method, for the calculation of the geometry and the layout of the drape, in particular in the areas close to the generating lines for turning over the surface as the area around the plane (25, FIG. 5a) containing the inflection points of the mandrel (20, FIG. 5a), patterns of which the fibers shrinkage is symmetrical in thickness are used, in order to avoid the weaving distortions during the turning-over.

In the method, the warp-weft weaving is replaced with a braiding, either biaxial at positive and negative angles around the axis, or triaxial, the third direction of which corresponding to the warps of the woven texture will roll up around the mandrel.

In the method, depending on the density of the material and its volumetric distribution in the woven or braided fabric, a virtual surface corresponding to the mid-thickness of the intended weaving is generated on which the turning-over or partial symmetry/symmetries and homothety process is then applied for the fabric on the weaving mandrel.

The method includes a step of constituting multiple layers of drape during the manufacture of the preform.

The method consists in producing the drape used for the preform by associating a weaving technique with a braiding technique.

In the method, during the deployment for draping of the part, deframing of the drape in shape is carried out, in order to properly cover the surface, the weft yarns will then follow the profiles (a, b, c, d, h) according to defined angles.

In the development of a part with the method, draped with several layers, it may be adopted for each of these layers one of the alternatives of the method which have been described, and thus associate woven drapes, deframed woven drapes and braided drapes, according to the stacking sequence of the desired fiber orientations.

What is claimed is:

1. A method for manufacturing composite material parts with preforms obtained by contour weaving of a kind comprising rolling up at least one part of drape by weaving or by braiding around a mandrel under a field of determined tensions, said method comprising:
during a first phase, carrying out a design of the part, a calculation of a geometry and the drape layout of a fabric-made preform and a calculation of at least one mandrel for forming a first manufacturing state of at least one preform;
during a second phase, carrying out a production of said at least one mandrel, calculated during the first phase, and of the drape of said at least one preform to be rolled up on said at least one mandrel;
during a third phase, extracting said at least one preform from the corresponding mandrel and applying thereto a determined radial extension, and/or, beyond an inflection point on the rolled up preform and/or into the radial extension, a determined geometric transformation which makes said at least one preform pass from a first manufacturing state to a second and last manufacturing state; and
carrying out the impregnation of said at least one preform in order to obtain the desired composite material parts.

2. The method according to claim 1, wherein the first phase further comprises at least from the determined geometry of said at least one preform to be manufactured:
one step of defining a layout of the drape of said at least one preform to be manufactured a section of which includes at least one extreme line separating at least two portions of said at least one preform;
one step of unfolding at least one portion of a distribution of the drape of said at least one preform beyond said at least one extreme line which is transformed into an inflection point eliminating any roll-over along a width of an axisymmetrically-shaped section; and
one step for deducting therefrom at least one revolving mandrel exhibiting a developed pattern similar to the distribution of the drape into two portions after the previous unfolding step.

3. The method according to claim 2, wherein the step for deducting therefrom at least one revolving mandrel comprises successively applying, from an adequate meshing of the last state of said at least one preform, geometric transformations of a type planar symmetry and/or axial homothety, and/or linear expansions in order to obtain a geometric definition of the forming mandrel of the contour weaving.

4. The method according to claim 1, wherein the step of calculating the geometry and the layout of the drape of said at least one preform uses a woven or braided textile layout, covering in only one coupon, a geometric shape of which an envelope surface comprises, in at least one plane perpendicular to an axis of revolution or an axis that is assimilated to the axis of revolution, at least two circumferential generating lines.

5. The method according to claim 1, wherein the first phase comprises at least some of the following steps:
a step E1 of meshing of the surface of the part to be draped;
a step E2 of identifying extreme generating lines of the obtained meshed surface;
a step E3 of generating a returned meshed surface by turning over different sub-surfaces of the obtained meshed surface by planar symmetries in order to eliminate the identified extreme generating lines;
a step E4 of generating a returned and reduced meshed surface by axial reduction from the obtained returned meshed surface by means of a similitude comprising an axial homothety with a positive coefficient smaller than 1 combined with a linear expansion, according to rules of preservation of circumferential developed patterns and rules of preservation of curvilinear distances along profiles of the surface, between the developed patterns, and finally definition of a mandrel for rolling up fabric exhibiting a developed pattern similar to the returned and reduced meshed surface;
a step E5 of defining the patterns for the weaving and/or braiding which will be realized and rolled up on said mandrel and by a method of transformations which are reversal to the transformations of the turning-over step then the reduction step.

6. The method according to claim 5, wherein, for the calculation of the geometry and the layout of the drape, transverse fibers have an angle defined relative to circumferential fibers, which is not necessarily equal to a 90° angle and wherein quadrilaterals that preserve sides having the same ratio between the longitudinal direction and the cross direction, are gradually generated over the entire surface of the part.

7. The method according to claim 5, wherein, for the calculation of the geometry and the layout of the drape, transverse fibers have an angle defined relative to circumferential fibers, which is not necessarily equal to a 90° angle and wherein quadrilaterals that preserve sides having the same ratio between the circumferential direction and the radial direction, are gradually generated over the entire surface of the part.

8. The method according to claim 5, wherein fibers of the drape for rolling up the mandrel are differentially pulled (or taken up) by the mandrel along a width of a loom, into the shape of the mandrel, or the shape of the previous layer already rolled up on the mandrel if several turns are rolled up on the same shape.

9. The method according to claim 5, wherein a contour weaving is realized so that:
there are provided several successive mandrels with adapted shape, there are provided counter-rolls to pull the weaving from a loom, before rolling up the weaving on a roll, while arranging a low tension on the latter, in order to preserve over a wide length of the weaving the same geometric shape defined by a fabric take-up mandrel.

10. The method according to claim 8, wherein, for producing a two-dimensional drape, the fibers are used to realize textile shapes.

11. The method according to claim 10, wherein the fibers are used to realize fabrics for parts made of composite materials of glass fibers, carbon fibers, Kevlar fibers or ceramic fibers.

12. A facility for manufacturing composite material parts implementing the method according to claim 1, said facility comprising:
a device for calculating a drape layout and a geometry of a preform on the basis of a given shape of a revolving part to be realized in a composite material and at least one mandrel for realizing a drape-made preform of said revolving part;
a device for realizing a drape reproducing the determined drape layout;
a mechanism for rolling up at least partially the drape with the determined layout around said at least one mandrel, then realizing a radial extension and/or a fold-up of a determined portion of the thus produced preform profile; and
a device for applying a polymerizable resin over the preform to produce therefrom the revolving part.
